(19) United States
(12) Patent Application Publication
(10) Pub. No.: US 2024/0164413 A1
(43) Pub. Date: May 23, 2024

(54) RETORT SYSTEM AND PROCESS

(71) Applicant: STOCK America LLC, Garner, NC (US)

(72) Inventors: Richard D. ELEEW, Madisonville, LA (US); Philip M. LeBlanc, Franklinton, LA (US)

(21) Appl. No.: 18/424,287

(22) Filed: Jan. 26, 2024

Related U.S. Application Data
(63) Continuation-in-part of application No. 17/479,431, filed on Sep. 20, 2021.
(60) Provisional application No. 60/086,224, filed on May 21, 1998.
(60) Provisional application No. 63/448,438, filed on Feb. 27, 2023.
(60) Provisional application No. 63/580,548, filed on Sep. 5, 2023.

(51) Int. Cl. A23L 3/10; A23L 3/00

(52) U.S. Cl. CPC A23L 3/10; A23L 3/001; A23L 3/003

(57) ABSTRACT

A retort system includes a vessel defining an interior volume, and a product holding structure received within the interior volume. The product holding structure includes: one or more inlet openings that together define a first flow area for receiving heat exchange liquid and one or more outlet openings that together define a second flow area for outflow of heat exchange liquid, the second flow area being smaller than the first flow area for limiting flow of heat exchange liquid out of the product holding structure. A heat exchange liquid flow system that is configured to direct heat exchange liquid into the product holding structure causing the product holding structure to fill with heat exchange liquid to at least a submersion level above products within the product holding structure while a level of heat exchange liquid outside the product holding structure and within the interior volume remains below the submersion level.

### TECHNICAL FIELD

The present application relates to commercial sterilization autoclaves (known in the industry as retorts), and in particular to systems and methods to commercially sterilize and render shelf-stable (or otherwise heat treat) previously packaged products through heat transfer from a process liquid in a controlled manner.

### BACKGROUND

To commercially sterilize many in-container foods, pharmaceuticals, nutraceuticals and other products, to make them “shelf-stable,” the products are subjected to a commercial sterilization method that includes heating the product in its sealed container to a predetermined temperature and maintaining the temperature for a product specific duration. Air Pressure above Saturated Steam may also be supplied to preserve the integrity of the product packaging. This process is commonly referred to as an autoclave process, retort process or a commercial sterilization process.

A retort is a pressure vessel commonly used in the food industry for commercially sterilizing and or pasteurizing food in a hermitically sealed container. A variety of acceptable commercial retort processes are known in the food industry, including for example, standard saturated steam, water immersion, cascade (also known sometimes as trickle or shower), and steam water spray retorting.

In a water spray process, heated water is circulated via a pump circulation loop that draws the water from a sump or reservoir in the bottom of the retort and pumps the water through a distribution header fitted with spray nozzles at the top and or sides of the retort. The distribution pipes typically run along the length of the vessel. Compressed air is used to develop overpressure in the retort throughout the process to offset the pressure differential inside the product container. There are typically 5-7 distribution headers with multiple spray nozzles positioned around the product load to distribute water throughout the load. Each nozzle has a given flow and spray angle required to assist with a desired homogeneous heat transfer.

Water cascade retorting is another acceptable process for pasteurizing and commercially sterilizing containers that require overpressure to ensure the integrity of the container. In a water cascade process, water is circulated via a pump circulation loop that draws the water from a sump or reservoir in the bottom of the retort and pumps the water through a distribution header located at the top and or sides of the retort. The header includes openings that allow water to flow down into a metal pan that runs the length of the retort above the product. The metal pan typically fills with water to a depth of about 12 mm to 20 mm, and has openings that allow the water to trickle or cascade from the pan (under the head pressure of the water depth in the pan), down to and through the product load. The openings are typically sized and spaced such that only between about 3% and about 6% of the pan surface is open. A typical diameter of the openings may be on the order of about 6 mm to 9 mm, with a density distribution to result in a center to center spacing between the openings of about 40 mm. The water is heated in the sump by direct steam or through a heat exchanger in the circulation loop.

Among the known retorting processes, standard water immersion provides effective heat distribution throughout the retort and penetration into the product to be commercially sterilized, but such full vessel systems require a large amount of heat transfer fluid and energy. In this application, the entire retort vessel chamber (also commonly referred to as the drum) is filled with heated water under pressure to completely immerse the product. Typically, the entire load of product containers is also rotated within the retort vessel chamber to stir the water and provide even heat distribution to the product. Because the outside shell of the retort vessel acts as a heatsink, and because the entire volume of liquid filling the interior of the vessel must be heated, this process requires a substantial amount of energy.

U.S. Patent Publication No. 2022/0106068, the entirety of which is incorporated herein by reference, discloses an alternative system and process in which a pumped flow of processing fluid is delivered through each product holding basket, in a columnar manner, using a delivery plenum above the baskets. In one variation, the delivery plenum(s) is/are moved downward into contact with the baskets to produce a substantial seal to provide good flow. In another variation, the product holding baskets are lifted upward into contact with the plenum(s) to provide the substantial seal. Improvements in the structure, operation and efficiency of this type of retort system are desirable.

### SUMMARY

In one aspect, a retort system includes a vessel defining an interior volume, the vessel including at least one door movable between open and closed positions; a support arrangement within the interior volume for receiving at least one product holding structure holding one or more packaged products to be treated; a heat exchange system, including a liquid circulation path having a discharge side, the heat exchange system configured to move a heat exchange liquid from the suction side to the discharge side; wherein the discharge side is fluidly connectable to a distribution feed system configured for feeding heat exchange liquid into the at least one product holding structure; wherein the suction side is fluidly connectable to pull heat exchange liquid from a lower region of the interior volume. A control system is configured to: (a) operate the heat exchange system such that heat exchange fluid is: (i) pulled from the interior vessel volume via the suction side, (ii) delivered through the pump and back to the interior vessel volume via the discharge side, (iii) into the at least one product holding structure via the distribution feed system, and (iv) through and out of the at least one product holding structure to the interior vessel volume; (b) monitor an indicator of a fill condition of the at least one product holding structure; (c) after the indicator indicates that the fill condition is achieved, drain some heat exchange liquid from the interior vessel volume, until a target processing level for the heat exchange liquid within the interior vessel volume and external of the at least one product holding structure has been reached, wherein the target processing level is below a level of heat exchange liquid within the at least one food product holding structure.

In a further aspect, a retort system includes a vessel defining an interior volume, the vessel including at least one door movable between open and closed positions; a support arrangement within the interior volume for receiving at least one product holding structure holding one or more packaged products to be treated; and a heat exchange system, including a liquid circulation path having a discharge side, a suction side and a pump operable to move a heat exchange liquid from the suction side to the discharge side. The discharge side is fluidly connectable to a distribution feed system configured for engaging the one or more product holding structures and delivering heat exchange liquid into the at least one product holding structure. The suction side is fluidly connectable to pull heat exchange liquid from a lower region of the interior volume. A control system is configured to: (a) fill the interior vessel volume with a heat exchange liquid to a preheat level; (b) operate the pump such that heat exchange fluid is: (i) pulled from the interior vessel volume via the suction side, (ii) delivered through the pump and back to the interior vessel volume via the discharge side, (iii) into the at least one product holding structure via the distribution feed system engaged with the at least one product holding structure, and (iv) through and out of the at least one product holding structure to the interior vessel volume; (c) monitor an indicator of a fill condition of the product holding structures; (d) after the indicator indicates that the fill condition is achieved, drain some heat exchange liquid from the interior vessel volume, until a target processing level for the heat exchange liquid within the interior vessel volume has been reached, wherein the target processing level is below a level of heat exchange liquid within the at least one food product holding structure.

In another aspect, a retort system includes a vessel defining an interior volume, and a product holding structure configured to be received within the interior volume. The product holding structure includes: one or more inlet openings that together define a first flow area for receiving heat exchange liquid and one or more outlet openings that together define a second flow area for outflow of heat exchange liquid, the second flow area being smaller than the first flow area for limiting flow of heat exchange liquid out of the product holding structure. A heat exchange liquid flow system that is configured to direct heat exchange liquid into the product holding structure causing the product holding structure to fill with heat exchange liquid to at least a submersion level above products within the product holding structure while a level of heat exchange liquid outside the product holding structure and within the interior volume remains below the submersion level. At least one level sensor is provided for monitoring liquid level within the interior volume and external of the product holding structure.

In implementations of the foregoing aspect, the heat exchange liquid flow system includes a distribution feed system configured for engaging the product holding structure and delivering heat exchange liquid into the at least one product holding structure.

In implementations of the foregoing aspect or implementations, the system further includes: a flow monitoring system associated with the liquid circulation path for monitoring volumetric flow along the liquid circulation path; and/or a liquid level monitoring system for monitoring a level of heat exchange fluid within the distribution feed system; and/or a distribution feed system temperature monitoring system for monitoring a temperature of the heat exchange liquid in the distribution feed system.

In a further aspect, a method for heat treating packaged products involves the steps of: using a retort vessel having an interior vessel volume, a heat exchange liquid circulation path having a discharge side, a pump, a suction side, and a distribution feed system in fluid connection with the discharge side; using at least one product holding structure holding packaged products; inserting the at least one product holding structure into the vessel; filling the interior vessel volume with a heat exchange liquid to a preheat level; heating the heat exchange liquid within the vessel to at least a target preheat temperature; after the target preheat temperature has been reached, operating the pump such that exchange fluid is: (i) pulled from the interior vessel volume via the suction side, (ii) delivered through the pump and back to the interior vessel volume via the discharge side, (iii) into the at least one product holding structure via the distribution feed system engaged with the product holding structures, and (iv) through and out of the at least one product holding structure to the interior vessel volume; monitoring an indicator of a fill condition of the at least one product holding structure; after the indicator indicates that the at least one product holding structure is filled with the heat exchange liquid, draining some heat exchange liquid from the interior vessel volume, until a target processing level for the heat exchange liquid within the interior vessel volume has been reached.

Other aspects and features are also provided.

### BRIEF DESCRIPTION OF THE DRAWINGS

FIGS. 1A, 1B and 2-10 show an exemplary retort system and associated vessel;

FIG. 11 shows a system schematic;

FIGS. 12-24 shows an exemplary processing operation sequence;

FIG. 25 shows temperature come up cool down for packaged products at various locations throughout a basket;

FIGS. 26-31 show another embodiment of the retort system vessel with additional features; and

FIG. 32 shows a variation of a system schematic similar to FIG. 10.

### DETAILED DESCRIPTION

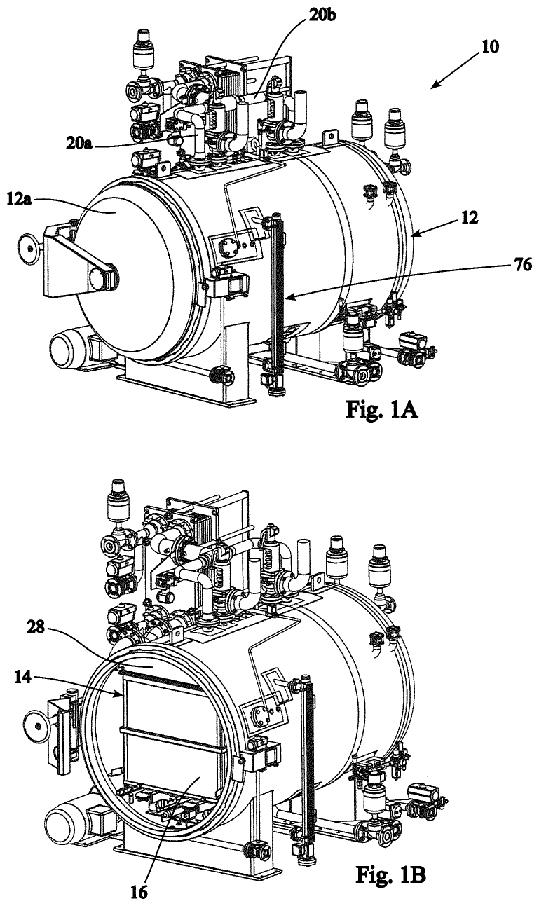

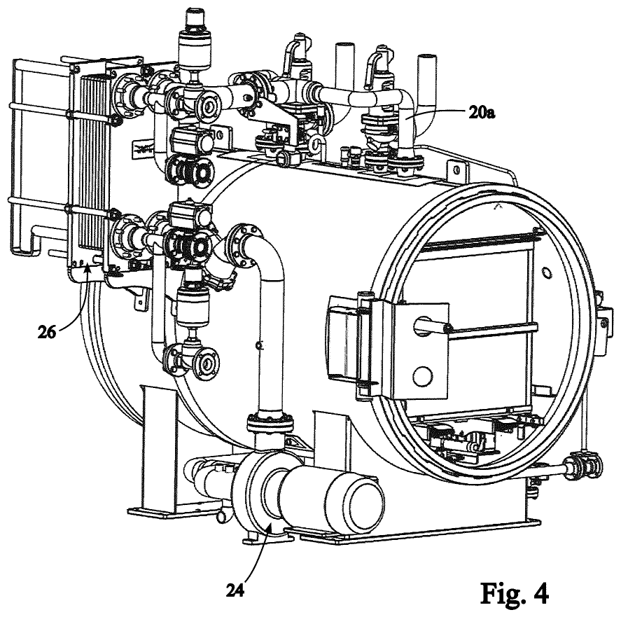

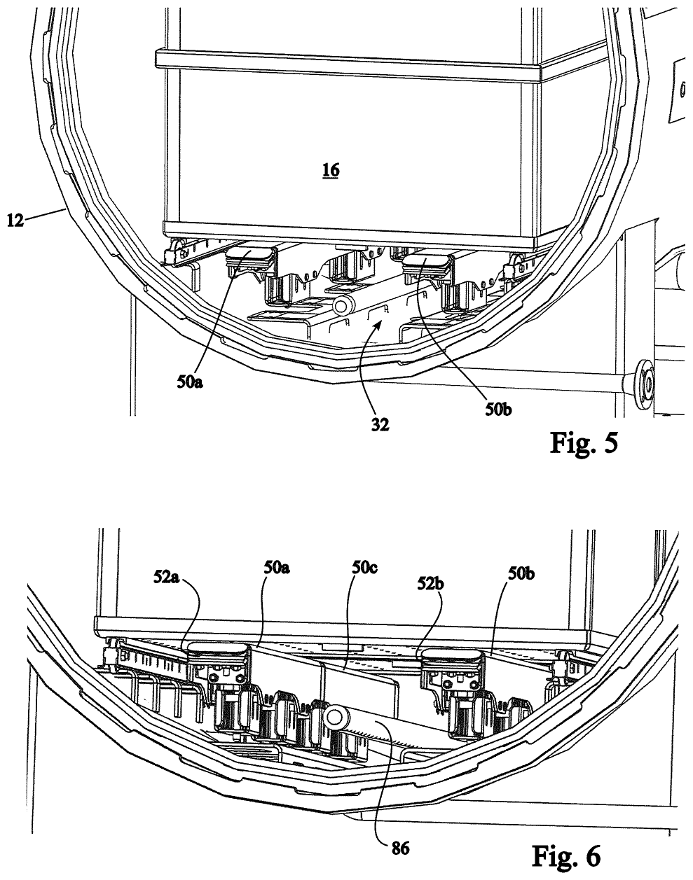

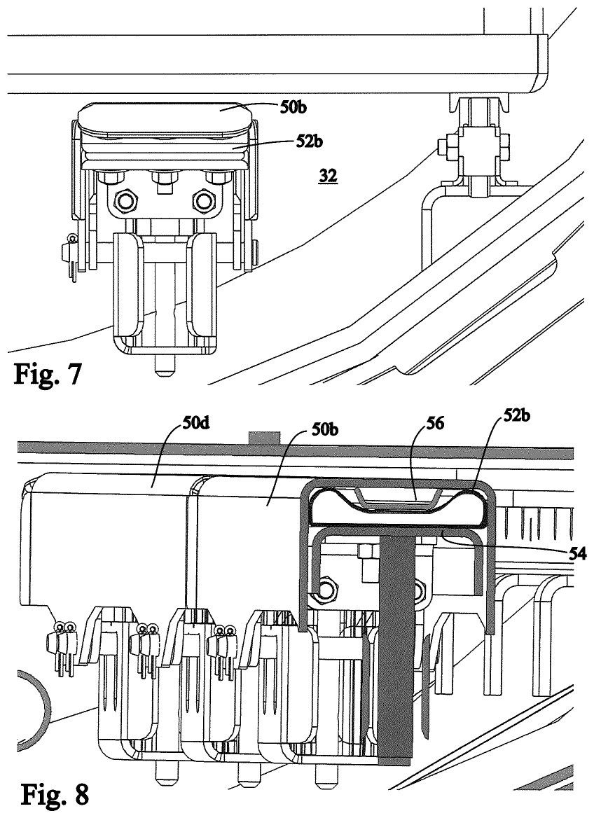

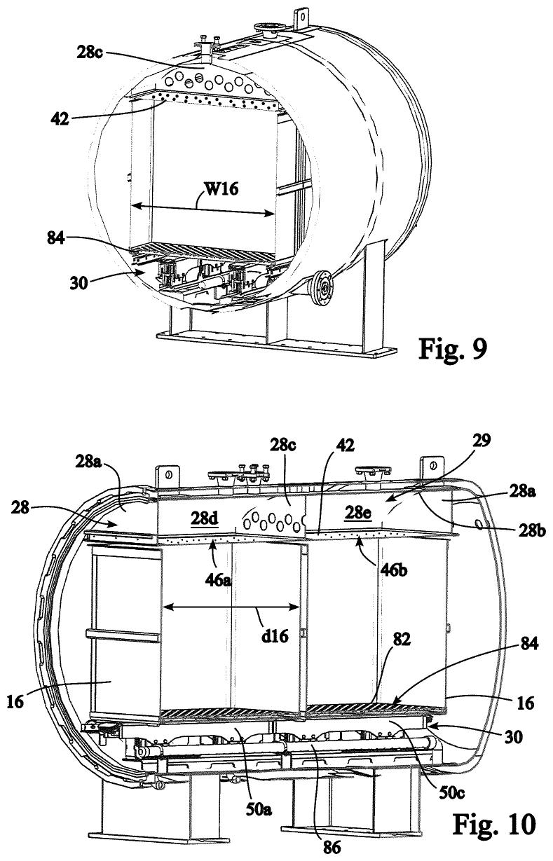

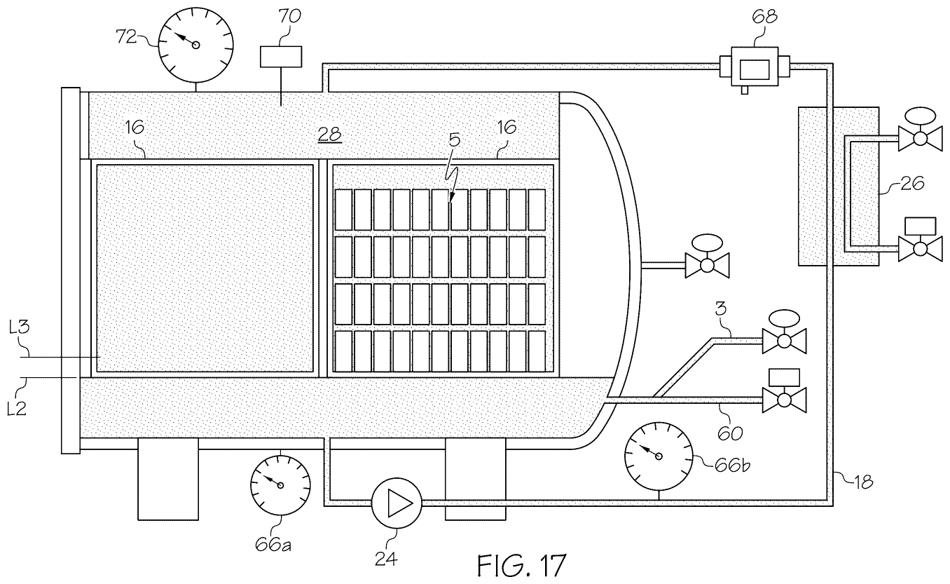

With reference to FIGS. 1A-11, a retort system 10 includes a main vessel body 12 that defines an interior volume 14, at least one removable product basket 16 that is received in the interior volume of the vessel, and a circulation loop 18 for circulating a heat exchange liquid (aka heat transfer liquid, process liquid or processing liquid), which typically will be water, through the retort system and, specifically, past the products 5 (FIG. 17) in the baskets 16 during the commercial sterilization process. The retort vessel body 12 typically includes a door 12a that permits the baskets 16 containing packaged products, such as canned or vacuum sealed food items, to be loaded into or removed from the interior volume 14. A two basket system is shown, but the invention contemplates any number of baskets (e.g., only 1, or 3 or more) being received in the interior volume of the retort system. The circulation loop includes a discharge side 20, a suction side 22, and a pump 24 that transports heat transfer liquid from the suction side to the discharge side. A heat exchanger 26, which may be driven by any of a wide variety of known heating or cooling elements, is operable to heat and/or cool the heat exchange liquid depending on the requirements of the commercial sterilization process. Here, the heat exchanger includes an input 23 selectively connectable via valve 23b to a cooling water input 23a or a steam input 23c (via valve 23d) for such purpose. In addition, or as an alternative to the heat exchanger 26, a direct steam heat system 27, with associated steam input 27a, can be provided that selectively injects steam (via control valve 27b) directly into the circulation path 18 for heating the heat exchange liquid during system operation (e.g., a Pick® steam injection system can be provided).

The discharge side 20 of the circulation loop 18 supplies heat exchange liquid to a discharge feed system or distribution feed system 29, which here includes a distribution plenum 28. The distribution plenum 28, which is located in the interior volume of the main retort vessel body 12, is designed to evenly distribute heat transfer liquid, under pressure, to the baskets 16. In the illustrated embodiment, the distribution plenum 28 is stationary and a basket lift system 30 can be actuated to close the gap 25 between the tops of the baskets and the underside of the plenum by lifting the baskets 16 (per arrow 21) into contact with the distribution plenum 28. Here, the plenum 28 is formed by fixed axial end walls 28a having upper edges engaged with the inwardly facing top surface 28b of the vessel, a lower plenum plate or plates 42 and an intermediate wall 28c with through openings to divide the plenum into respective sides 28d and 28e located over each basket, respectively. The lower plenum plate or plates 42 include two sets of outfeed openings 46a and 46b, each set configured in a manner to feed heat exchange liquid downward into the respective product basket therebelow in a distributed manner across the top opening area of the basket (i.e., multiple liquid paths are provided and distributed across a width W16 and axial depth d16 of each basket).

The baskets 16 may be specially designed to form closed fluid passageways or columns within the interior volume of the retort vessel where packaged products can be subjected to controlled temperature and pressure regimes. For example, the vessel itself may be pressurized (e.g., by air through compressed air path 3 under control of valve 3a from a compressed/pressurized air input 3b under valved control) to a defined range (e.g., 22-60 psi). Each basket 16 has an open top to receive liquid from the distribution plenum 28, substantially solid side walls, and a flow limiting plate 84 (aka the sieve plate), with orifices 82 sized to limit flow, in, and/or near, the bottom of the basket. The dimensions of the flow control orifices and the flow rate of the pump 24 can be selected to cooperatively cause the baskets 16 to fill with heat exchange liquid during the retorting process, yet drain when the process is completed. Specifically, by restricting outflow using flow control orifices in or near the bottom of the baskets, inflow supplied by the pump will rapidly fill the baskets and then the heat exchange liquid will be pumped through the baskets in a columnar flow. The orifices 82 are also distributed across the width and axial depth of the basket to provide for relatively good vertical flow through all parts of the basket. Heat exchange liquid that exits from the baskets 16 collects in a reservoir or sump 32 in the bottom of the retort vessel, which feeds the suction side 22 of the circulation loop. Each axial side of the plenum 28 can be fed by a respective input line 20a, 20b of the discharge side (e.g., one input line per basket) to provide for good flow distribution as between the multiple baskets.

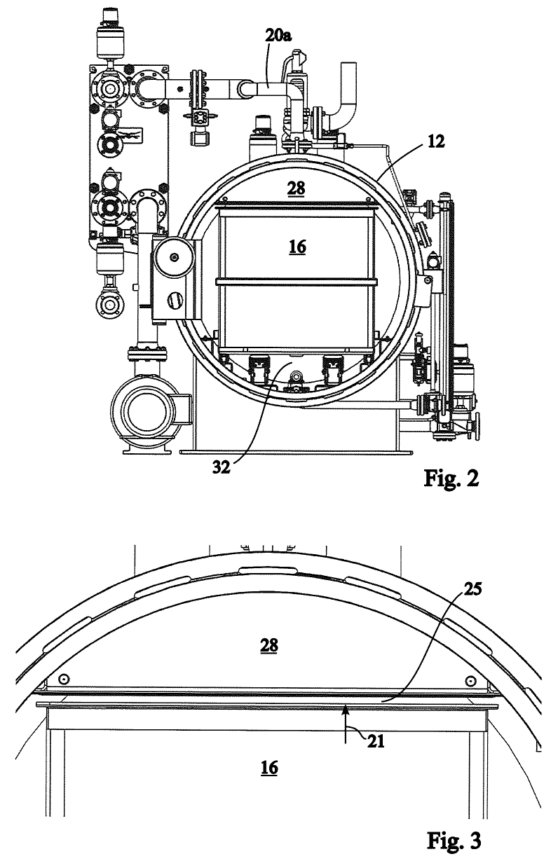

Here, the basket lift system 30 is in the form of an actuation system that utilizes a pair of spaced apart lift rails 50a, 50b for one basket and 50c, 50d for the other basket, where the lift rails have a normal position below the load/unload height of the baskets on the load/unload tracks, per FIG. 7. Rails 50a, 50c are shiftable upward via filling of a bladder 52a therebeneath, and rails 50b, 50d are shiftable upward via filling of a bladder 52b therebeneath. The bladders sit on support plates (e.g., 54) such that inflation of the bladders pushes the lift rails upward into contact with the baskets to lift the baskets up into contact with the plenum. A deflation plate 56 is provided to ensure air deflates fully when released from the bladder, and the lift rails are biased downward by a spring system. Here, although rails 50a and 50c are shifted upward by the same bladder, the rails 50a and 50b can move independently of each other, due to lack of a rigid mechanical connection between the rails 50a and 50b, which enables each basket to be moved slightly differently as needed to seat against the plenum plates, accounting for variations in basket tolerance etc. Alternatively, each bladder could be assigned to lift only one basket. Thus, the lift system shifts the baskets from load/unload heights in which the tops of the baskets are spaced from the plenum, per FIG. 2, to raised operating heights in which the tops of the baskets engage with and substantially seal against the bottom surface of the plenum plate, per arrow 21 of FIG. 3.

In terms of the sealing, a perfect seal is not required, and some leakage externally of the baskets may occur. However, the substantial seal should, given the flow rate, be a seal sufficient to cause the baskets to fill, and thus the plenum to substantially fill during pumped flow. Note that the flow from the pump 24 into the plenum is not restricted by the plenum plate 42 openings (e.g., the plenum plate openings provide sufficient flow area for the plenum to drain without filling), and it is only the restricted flow caused by the more restricted flow area of the sieve plate openings 82 in the plates 84 that causes the baskets to fill and then the plenum to fill. In terms of plenum fill, in some implementations, there may be some compressed air in the top of the plenum even when the plenum is deemed full for the purpose of operation.

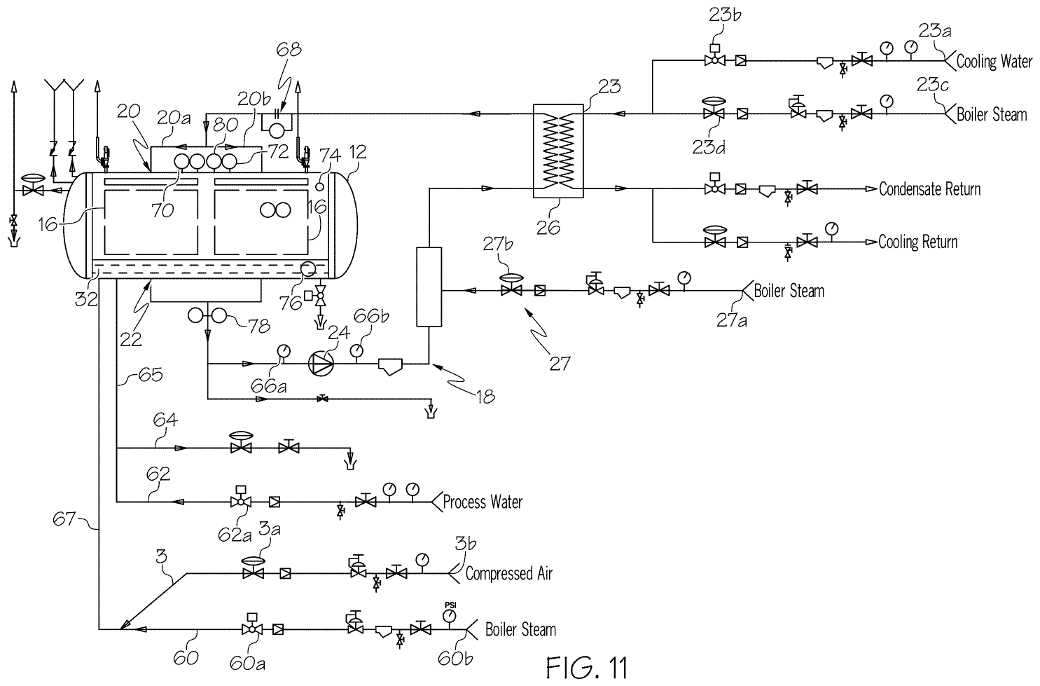

Referring to FIG. 11, the compressed air path 3 is joined to a steam injection path 60 for feeding into the retort vessel to preheat the reservoir. A process water infeed path 62 and drain path 64 are provided and, here, join and therefore partially overlap in path/line 65.

The system includes a differential pressure monitoring system (e.g., including pressure indicators 66a, 66b, such as manometers) for monitoring a differential pressure across the pump 24. A flow monitoring system (including flow meter 68) is associated with the circulation path for monitoring volumetric flow along the circulation path. A distribution feed system liquid level monitoring system (including level sensor 70) is provided for monitoring a level of heat exchange fluid within the distribution feed system (e.g., within the plenum). A distribution feed system pressure level monitoring system (including pressure sensor 72) is provided for monitoring a pressure condition in the distribution feed system (e.g., pressure in the manifold, which is also indicative of pressure in the baskets). An interior vessel volume pressure level monitoring system (including pressure sensor 74) and an interior vessel volume liquid level monitoring system (including level sensor 76, which may comprise an external tubular member fluidly connected to the vessel at both a bottom and a top of the tubular member, such that the liquid level in the tubular member matches that of the vessel) are provided for monitoring pressure within the vessel and a level of the heat exchange liquid within the interior vessel volume, respectively. A vessel temperature monitoring system (including temperature sensor 78 positioned in the circulation path) is provided for monitoring a temperature of the heat exchange fluid in the interior vessel volume, and a distribution feed system temperature monitoring system (e.g., including temperature sensor 80) is provided for monitoring a temperature of the heat exchange liquid in the distribution feed system (e.g., in the plenum).

The retort system also includes a path line 60 for steam injection into the vessel, under control of valve 60a, from a steam input 60b. Here, the steam input path 60 joins with and partially overlaps with compressed air input path 60 at path/line 67.

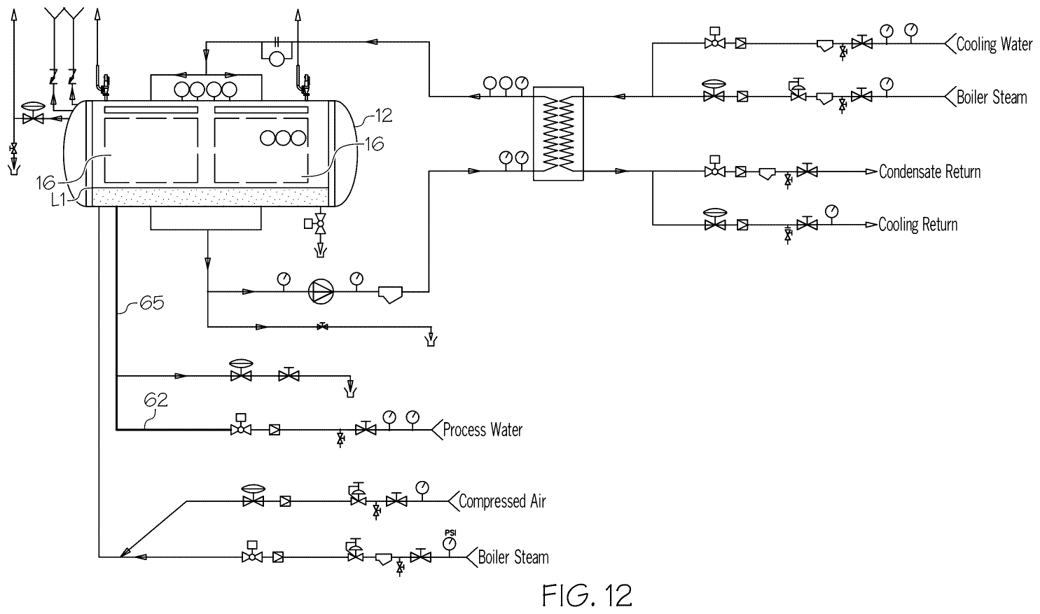

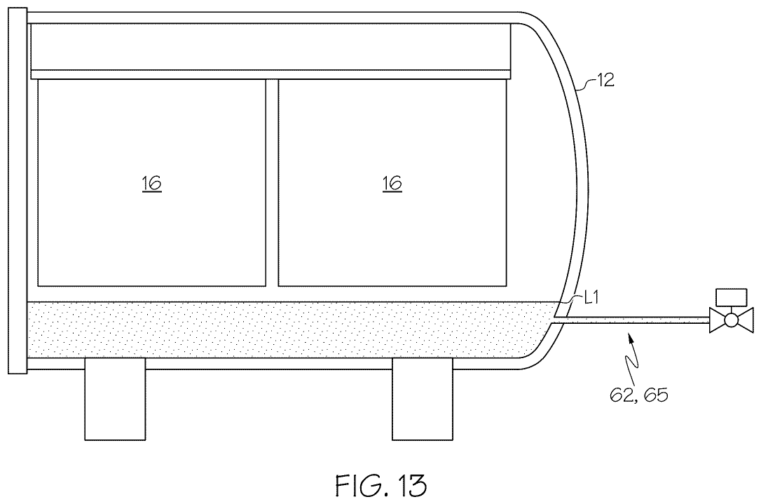

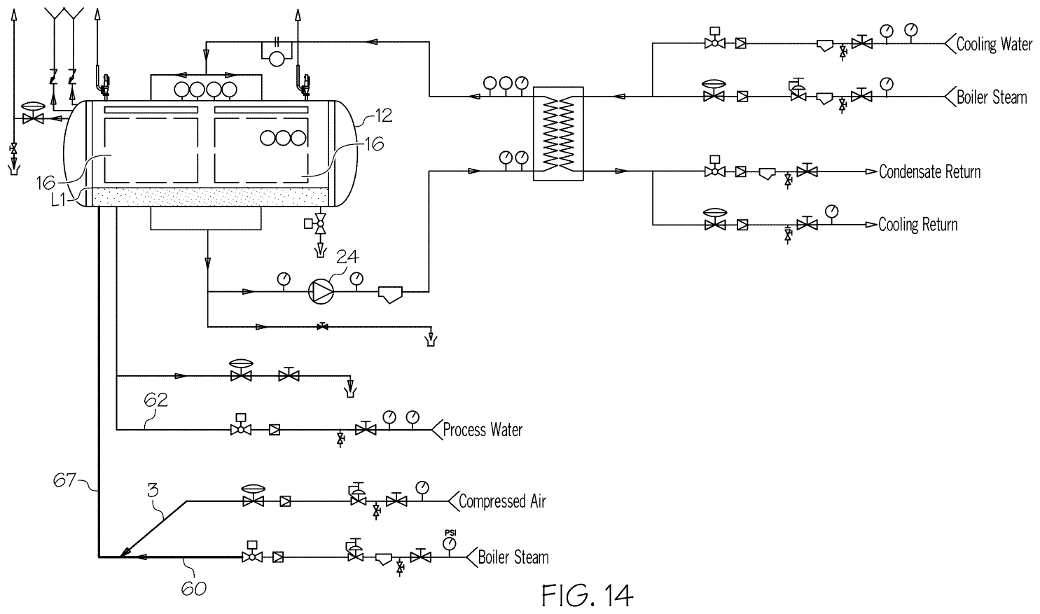

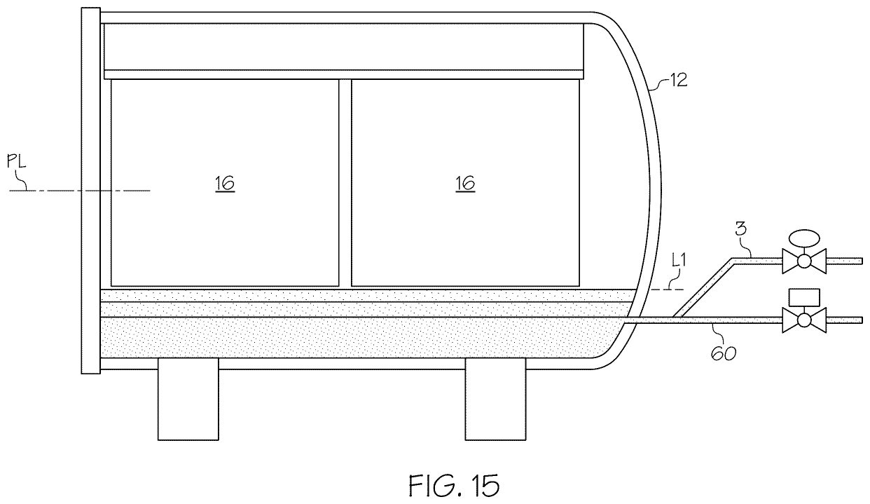

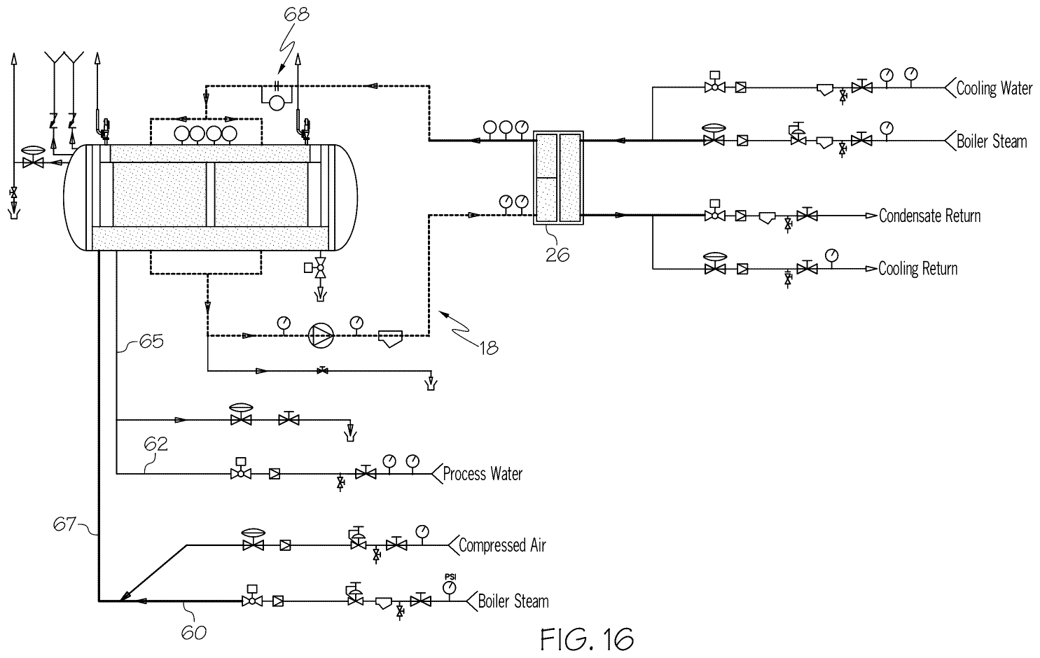

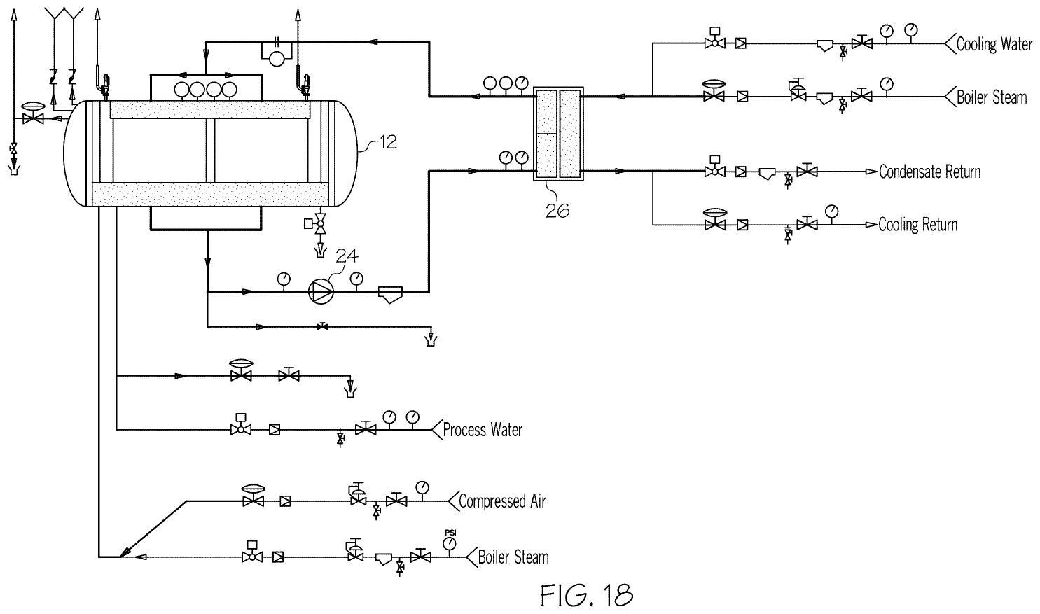

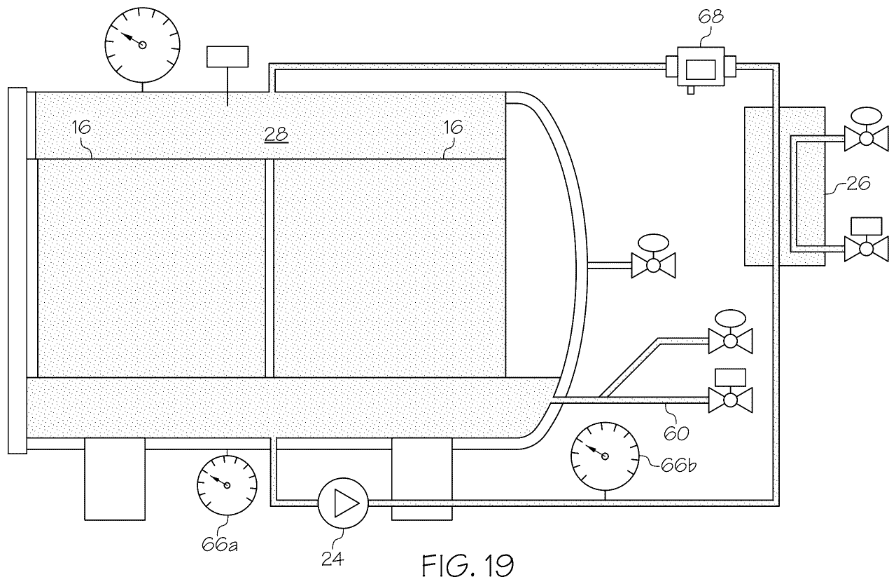

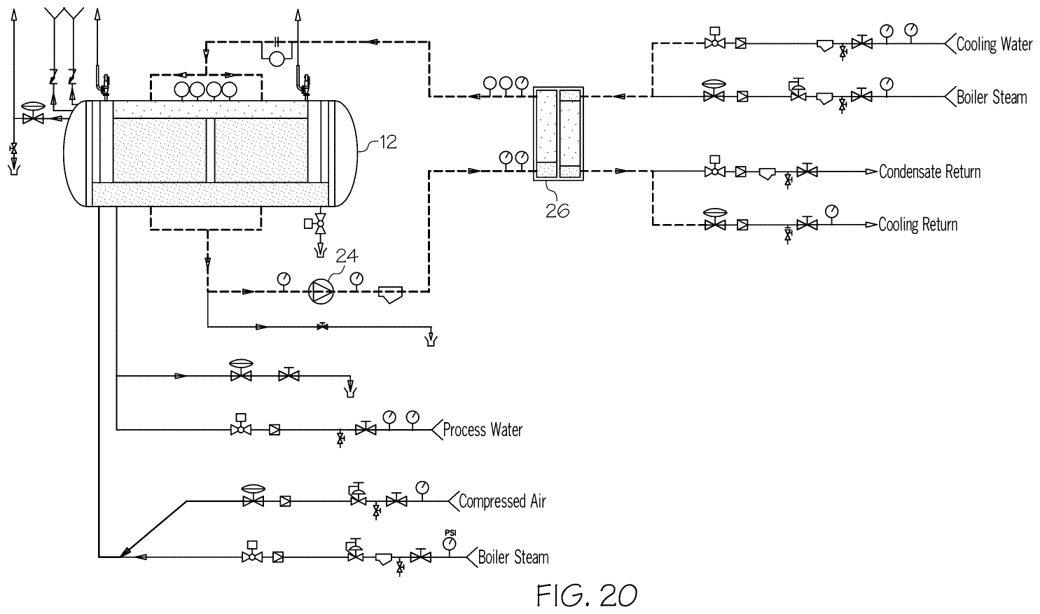

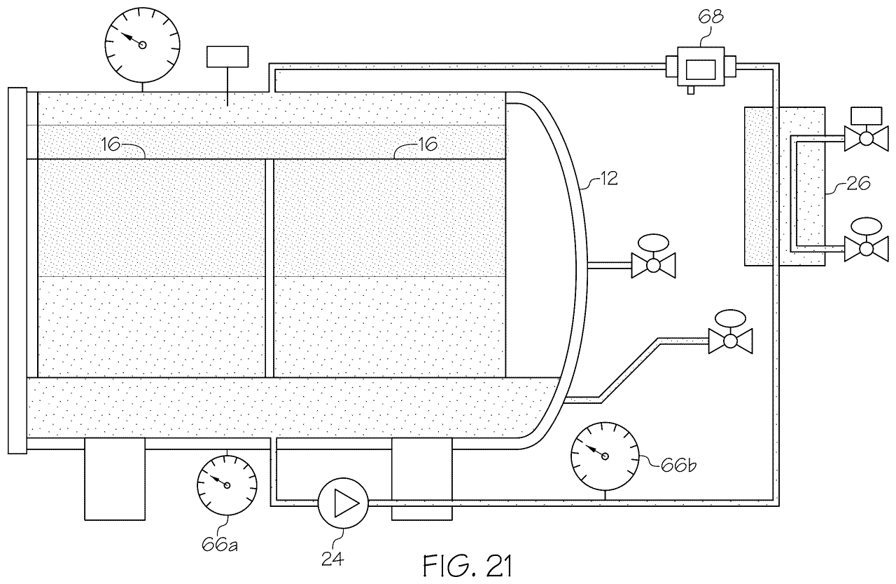

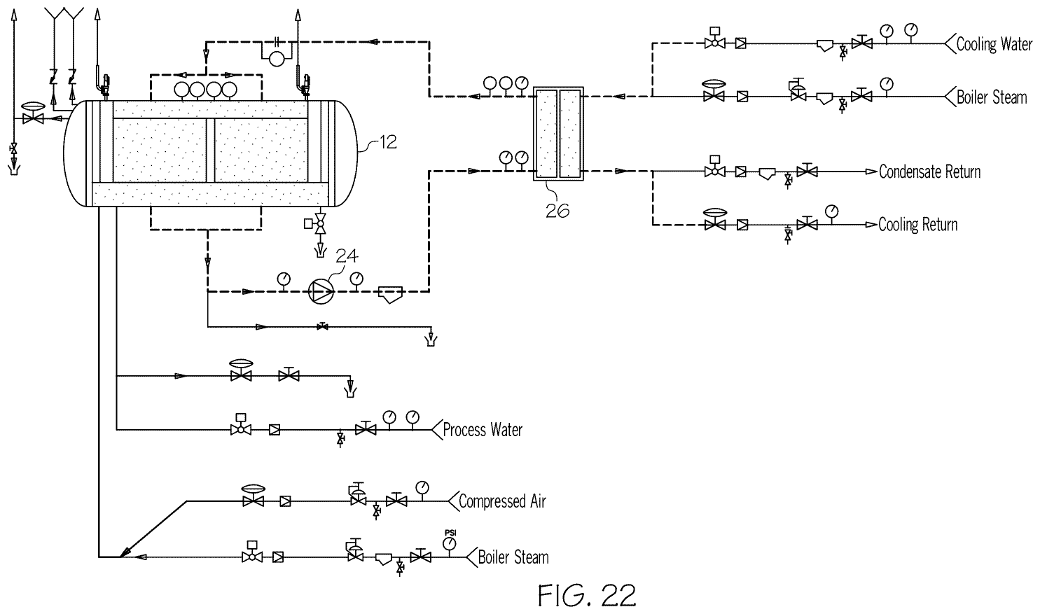

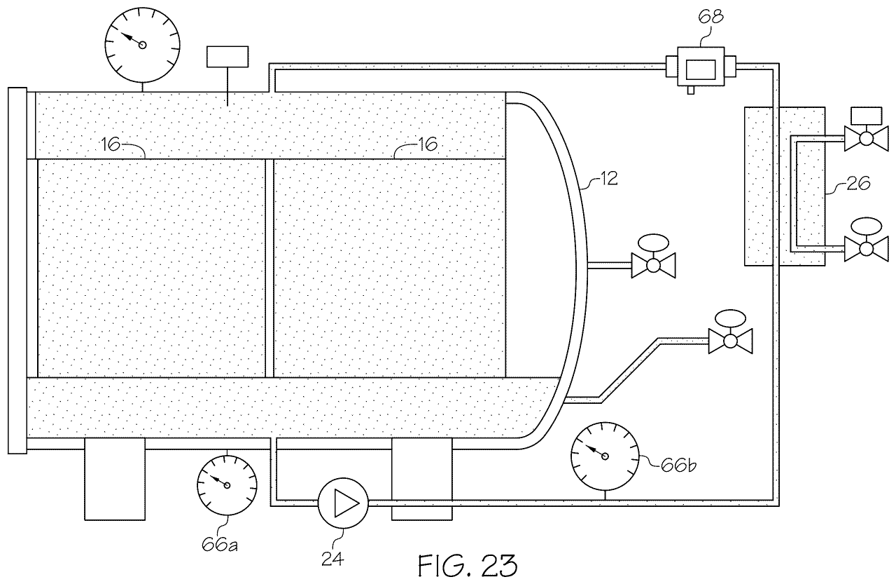

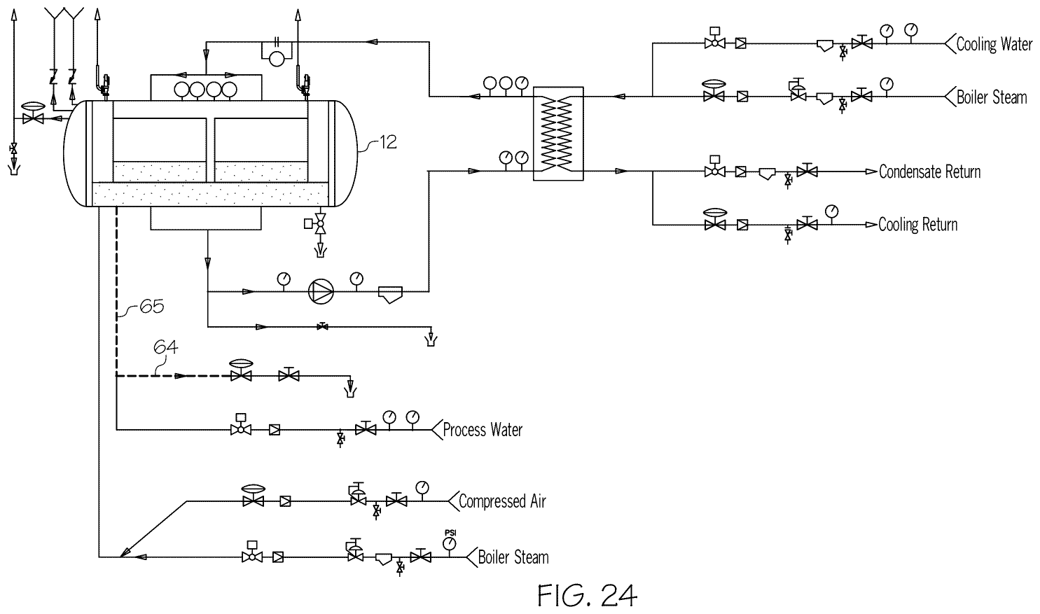

FIGS. 12-24 show an exemplary process operation for the retort system after baskets containing packaged products have been loaded into the vessel. Per FIGS. 12 and 13, process water is fed into the vessel via path 62, 65 to a level L1 below the baskets. Per FIGS. 14-15, the water is then heated via steam injection along path 60, 67 and the vessel may be pressurized, as desired, via compressed air injection via path 3, 67. The vessel is then filled (via path 62, 65) with sufficient water as the water continues to be heated via path 60, 67 until the water has reached a suitable temperature, and operation of the pump 24 is initiated to begin the flow along the circulation path, per FIGS. 16-17, and the water continues to be heated via steam injection to the vessel and via the circulation path heat exchanger 26. Once the water reaches the desired processing temperature, the steam injection directly to the vessel can be stopped, and the pump 24 continues to operate for an established processing time to bring the packaged products up to temperature, with any necessary additional heating to maintain desired water temperature being provided by heat transfer from the steam to the water via the heat exchanger 26, per FIGS. 18-19. Per FIGS. 20-21, the water can then be cooled via the heat exchanger 26 to bring the temperature of the packaged products back down, during a pressure cool phase, where pressure is maintained in the vessel to prevent container damage. After the packaged products have cooled sufficiently to eliminate the risk of container rupture, atmospheric cooling can take place via the water circulation, per FIGS. 22-23. Finally, when the treatment process is complete (after heating and cooling), the vessel and baskets can be drained via path 65, 64, and the baskets removed from the vessel.

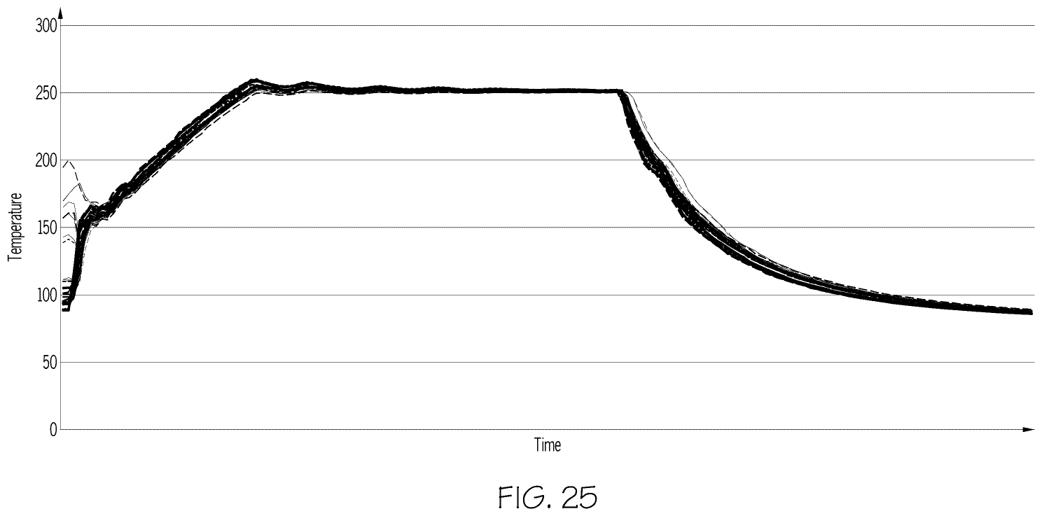

As seen in FIG. 25, a major advantage of the described system with pumped columnar flow through the baskets is that come up times (Starting to Process Temps) are very fast, and the temperature conditions throughout each basket are relatively uniform due to the nature of the pumped flow (i.e., little or no flow dead spots in the baskets).

Thus, the described retort system provides a method for heat treating packaged products, the method involving the steps of: using a retort vessel having an interior vessel volume, a heat exchange liquid circulation path having a discharge side, a pump, a suction side, and a distribution feed system in fluid connection with the discharge side; using a plurality of product holding structures (e.g., baskets), each holding packaged products; inserting the plurality of product holding structures into the vessel; filling the interior vessel volume with a heat exchange liquid to a preheat level; heating the heat exchange liquid within the vessel to at least a target preheat temperature; after the target preheat temperature has been reached, operating the pump such that exchange fluid is: (i) pulled from the interior vessel volume via the suction side, (ii) delivered through the pump and back to the interior vessel volume via the discharge side, (iii) into the product holding structures via the distribution feed system engaged with the product holding structures, and (iv) through and out of the product holding structures to the interior vessel volume; monitoring an indicator of a fill condition of the product holding structures; after the indicator indicates that the product holding structures are filled with the heat exchange liquid, draining some heat exchange liquid from the interior vessel volume, until a target processing level for the heat exchange liquid within the interior vessel volume has been reached; and continuing to operate the pump for heat treating of the packaged products in the product holding structures. In one implementation, the target processing level is slightly below the bottom outlet openings of the product holding structures. In another implementation, the target processing level is at or slightly above the bottom outlet openings of the product holding structures. In the latter implementation, by having the bottom portion of the product holding structure submerged in the sump water volume, the water exiting out of bottom openings of the product holding structure is already below the sump water surface and therefore will not introduce and entrain air bubbles into the sump.

In implementations, the draining operation occurs via a drain path that is separate from the circulation path or partially overlaps with the circulation path.

In implementations, the preheat level comprises a first preheat level and a second preheat level, the first preheat level being below the product holding structures and the second preheat level being at a height that submerges part of the product holding structures, wherein filling of the interior vessel volume from the first preheat level to the second preheat level is not initiated unless and until a temperature of the heat exchange liquid in the interior vessel volume is above the initial temperature of the packaged products.

In implementations, the preheat level comprises a first preheat level and a second preheat level, the first preheat level being below the product holding structures and the second preheat level being at a height that submerges part of the product holding structures, wherein filling of the interior vessel volume from the first preheat level to the second preheat level is carried out in a controlled manner, in combination with heating of the heat exchange liquid, to assure that a temperature of the heat exchange liquid in the interior vessel volume is above the initial temperature of the packaged products at all times.

The described retort system also provides a method for heat treating packaged products, the method involving the steps of: using a retort vessel having an interior vessel volume, a heat exchange liquid circulation path having a discharge side, a pump, a suction side, and a distribution feed system (e.g., plenum) in fluid connection with the discharge side; using a plurality of product holding structures, each holding packaged products; inserting the plurality of product holding structures into the vessel; raising the product holding structures (e.g., baskets) into engagement with the distribution feed system (e.g., plenum); capturing the initial temperature (IT) of the packaged products (e.g., as input by an operator via Operator input); use this initial temperature input to define Low IT (where Low IT=IT+X, where X is, for example, between 3° and 10° F.); open the water input valve 62a to begin vessel fill in the lower reservoir of the vessel; determine when water level in the vessel reaches a minimal level injection point; once there is enough water above the steam/air input of the vessel (e.g., a sparge tube 86 in the lower part of the vessel is submerged) open the steam and air valves 60a and 3a; verify the control loop is maintaining a reservoir temperature greater than Low IT; continue adding water to a Process Level (e.g., a level PL (FIG. 15) that partially overlaps with the baskets); stop water fill if the vessel water is dropping in temperature (e.g., if IT is 150° F., and Low IT Setpoint is 155° F., then the water valve 60a is closed whenever the vessel water temperature drops to 154°); as soon as both Water Level in the vessel reaches the Process Level and the water temperature is at the Low IT setpoint, the circulation pump 24 is started; due to the basket restrictions, water fills the plenum and the baskets creating a full immersion effect of the packaged products; once the water level in the plenum is identified as reaching a set fill level, the flow system has reached equilibrium and the water level in the vessel reservoir is checked, and any water above a defined operating level, is drained off creating an operating level condition. In one implementation, the defined operating level may be a level L2 (FIG. 17) providing a water break between the bottom of the basket sieve plates and the top of the suction port to the pump 24, and just enough water level is needed to prevent cavitation of the pump 24. In another implementation, the defined operating level may be a level L3 that is sufficient to slightly submerge the bottom(s) of the basket(s). In either case, the pump continues to be operated (with heat exchanger and/or steam inject adding heat as needed) to continue to bring up the temperature of the water, and thus the packaged products, to an established target processing temperature (e.g., between 220° F. and 280° F., such as between 240° F. and 260° F.) for the duration of the product heating portion of the process. The above method reduces the overall water in the system, by draining out excess water that is not needed, resulting in faster and more efficient heating of the packaged products via the water being pumped through the baskets.

Thus, the system and/or method provides for self-adjusting preheat level/temperature for displacement. In particular, with the possibility of various container geometries creating unique displacements in the baskets, the control sequence is designed to self-adjust level for any containers open voids created by the loading pattern of the product in the container. Level, in conjunction with the need to remain at a temperature setpoint equal to or greater than the products Initial Temperature (Product Starting Core Temperature) is validated as a Critical Control Point (CCP) Level and Temperature together in a closed silo in suspension from the bottom of the sieve plate to the top of the plenum arc is the bias for the process. As ambient temperature water enters the lower reservoir direct steam is injected. Water and temperature are continuously monitored. If the temperature of the incoming water is lower than the product's initial temperature the entry of incoming water is stopped until the temperature exceeds the product initial temperature. This control loop is maintained until the process water reaches displacement level. Displacement is a predefined level setpoint which ensures there is adequate process water to fill the entire silo from the bottom sieve to the top of the plenum arc. With displacement level obtained and preheat temperatures stable the circulation pump is activated and the software validates process water circulation by multiple means of verification. The starting displacement level drops as voids in the plenum chamber and open area between the containers are filled with process water. To ensure a full hydraulic silo of water is obtained a vent valve located in the top of the plenums arc is ported to the internal, non-flooded portion of the process vessel. As the level stabilizes and instrumentation validates a full silo of process water, residual water is drained to an operating level optimized for the process.

In embodiments, the baskets are raised upon closure of the vessel door, and the fluid system will not initiate unless and until the baskets are determined to be raised (e.g., no vessel fill or heating will take place until the baskets are raised (e.g., as indicated by the bladders being full and under pressure).

In various examples or modes, the distribution feed system liquid level monitoring system is used, at least in part, to verify that the product holding structures are filled with the heat exchange liquid.

In various examples or modes, the flow monitoring system is used, at least in part, to verify that the product holding structures are filled with heat exchange liquid.

In various examples or modes, the vessel temperature monitoring system and the distribution feed system temperature monitoring system are provided, and a differential temperature between the systems in excess of a set threshold is utilized to take a control action, such as an alarm or an alert.

In various examples or modes, the distribution feed system pressure level monitoring system and the interior vessel pressure level monitoring system are provided, and a differential pressure between the systems in excess of a set threshold is utilized to take a control action, such as an alarm or alert.

Tables 1 and 2 below provide additional reference for use(s) of the various sensor systems.

TABLE 1
Exemplary Control/Process Logic

| | | Critical | |
|---|---|---|---|
| Instrument | Mode | Control Point | Logic |
| Differential | Digital | Verify both | Differential Pressure Switches are connected |
| Pressure | | off for | to the suction port and discharge port to |
| Switches | | continuous | verify the differential pressure generated by |
| Before and | | optimal | the suction of the pump flow. The |
| After | | pump curve | information will log as part of batch report |
| Circulation | | | trend data that can be used to analyze |
| Pump | | | differential pressure, flow, water levels and |
| | | | come up times. |
| Flow Meter | Analog | Validates | This reading can be used to validate required |
| | | flow rates | flow rates to achieve product sterilization as |
| | | associated | defined by Temperature Distribution testing. |
| | | with process | During process validation a low flow rate |
| | | validation | can be tested to challenge the system to |
| | | | determine the low flow threshold in which |
| | | | the system can still achieve sterilization. The |
| | | | system will monitor the water flow during |
| | | | the process and alarm if the flow drops too |
| | | | low. The flow rate is also one of the process |
| | | | values used in analysis and monitoring the |
| | | | process to guarantee that the product basket |
| | | | is “immersed” in water. |
| Plenum Level | Analog | Indicates Full | The water level temperature transmitter is |
| | | Level in | used to monitor that the required water level |
| | | plenum | (volume) is achieved/maintained to immerse |
| | | | the product in water. If a low water level is |
| | | | detected, this indicates that the water is not |
| | | | flowing via the basket and a seal problem |
| | | | between the basket and the plenum may |
| | | | exist. If a high water level is detected, this |
| | | | indicates probably obstruction on the plenum |
| | | | or basket. The critical levels will be |
| | | | monitored, logged and used to alarm. |

TABLE 2
Exemplary Control/Process Logic

| | | Critical | |
|---|---|---|---|
| Instrument | Mode | Control Point | Logic |
| Plenum | Analog | Indicates | If pressure indicates 1 PSI above vessel |
| Pressure | | Pressure in | pressure this denotes possible sieve or |
| | | plenum | plenum obstruction |
| Reservoir Level | Analog | Indicates | Used to fill reservoir to level which allows |
| | | Level in | for operating level based on container |
| | | Reservoir for | displacement. Secondly, used to self-adjust |
| | | Initial Fill | operating level after water suspension in the |
| | | and | basket. This routine ensures the lowest |
| | | Operating | possible operational level by utilization of a |
| | | Level | self-adjusting control routine. |
| Vessel | Analog | Indicates | If lower than specified process temperature |
| Temperature | | Control | go to deviation process schedule. Self-adjust |
| Primary | | process | the thermal process in real time. Alarm and |
| | | temperature | log |
| Vessel Plenum | Analog | Indicates | If there is a Delta between vessel temp and |
| Temperature | | temperature | plenum temp this may indicate a clogged |
| | | in plenum | heat exchanger |

As used herein the term “fluidly connectable” encompasses actual connections that enable fluid flow as well as arrangements that selectively enable fluid flow (e.g., by opening of a valve or by providing two parts of a flow path that are movable into connection with each other on a selective basis).

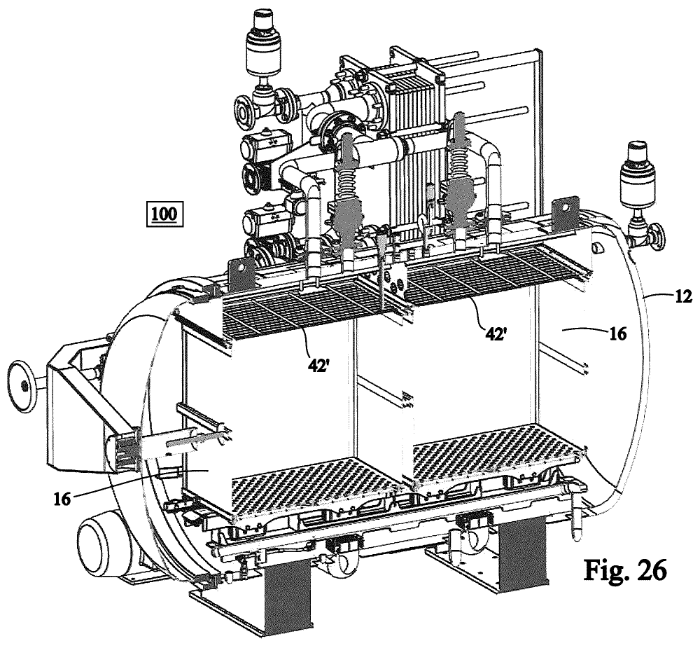

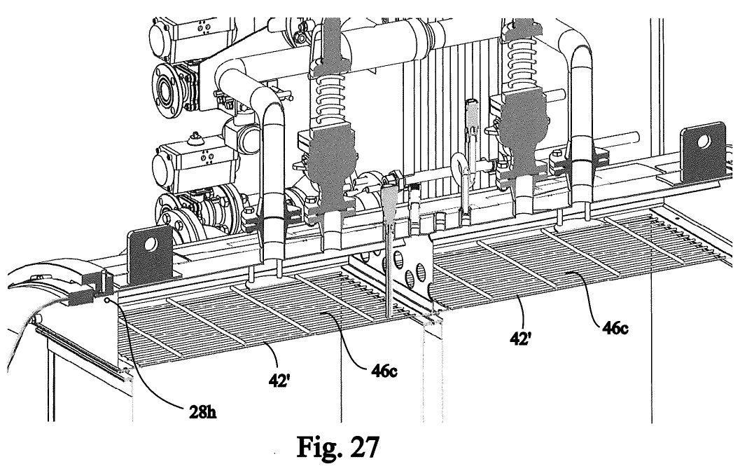

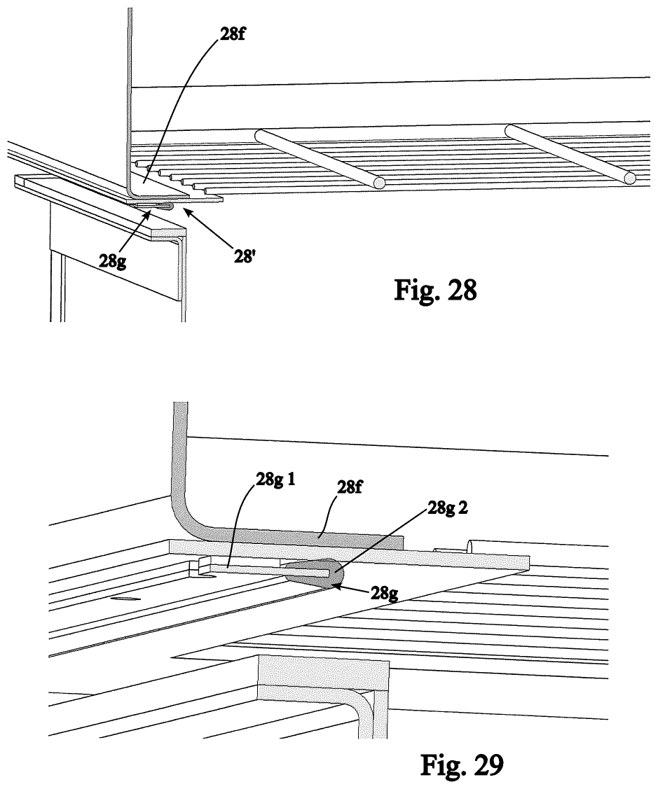

Although plenum plates with orifice openings are shown and described above, in alternative embodiments, other forms of distribution structures could be used, such as the wire rod grate structures 42′ shown in FIGS. 26-29, where the openings 46c in the structure are shaped as elongated slots. Both the grate structures 42′ and the plenum plates 42 also help to assure product at the top of the baskets is retained in the baskets (e.g., preventing product from floating or otherwise being dislocated from its intended load pattern). The embodiment of FIGS. 27-30 also shows a distribution plenum structure 28′ having a lower peripheral flange 28f to which is mounted a gasket structure 28g in the form of a plate 28g1 and a elastomeric or other sealing structure 28g2, which helps to account for manufacturing irregularities in the baskets and/or plenum surface flatness. The plenum may also include a vent structure 28h (e.g., here in one of the plenum end walls, but alternatively elsewhere) that allows air from within the baskets and/or plenum to be displaced into the vessel as the baskets fill with heat exchange liquid. In embodiments, the vent 28h may include a valve the permits manipulation/control.

An exemplary controller 100 is also shown schematically in FIG. 26. As used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group—including hardware or software that executes code), software, firmware and/or other components, or a combination of some or all of the above, that carries out the control functions of the device or the control functions of any component thereof.

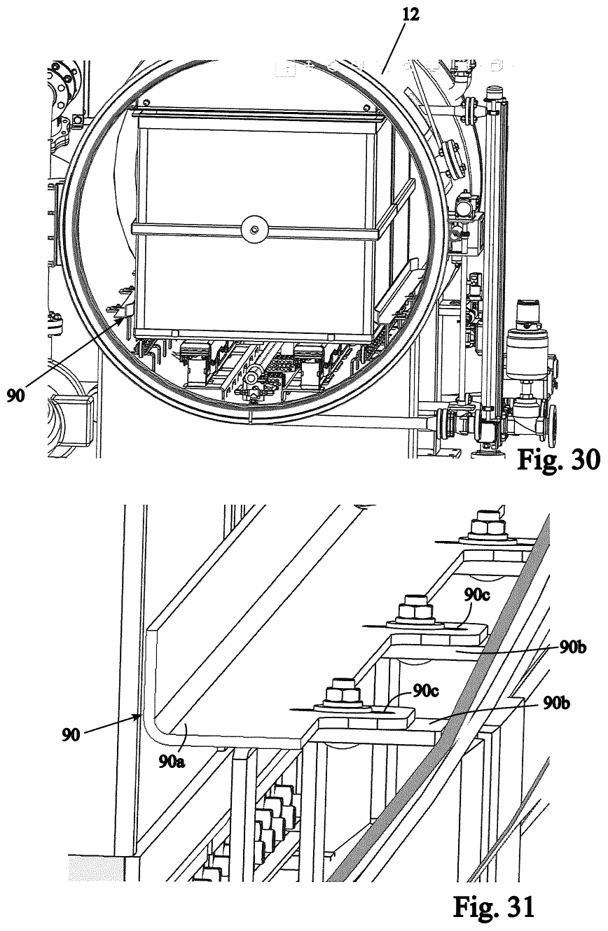

Per FIGS. 30-31, the vessel may also include basket alignment guides 90 (here as side rails 90a with outwardly angled end segments for basket entry) to provide more assured targeting of the upper end of the basket against the plenum (and particularly against the gasket) when the baskets are raised. Notably, the alignment guides 90 are at a height that is sufficient to maintain guiding contact with the baskets as they are raised. The alignment guides 90 may also be adjustable (along the width of the baskets), as by the rails 90a being mounted to brackets 90b via fasteners passing through elongated slots 90c of the rails.

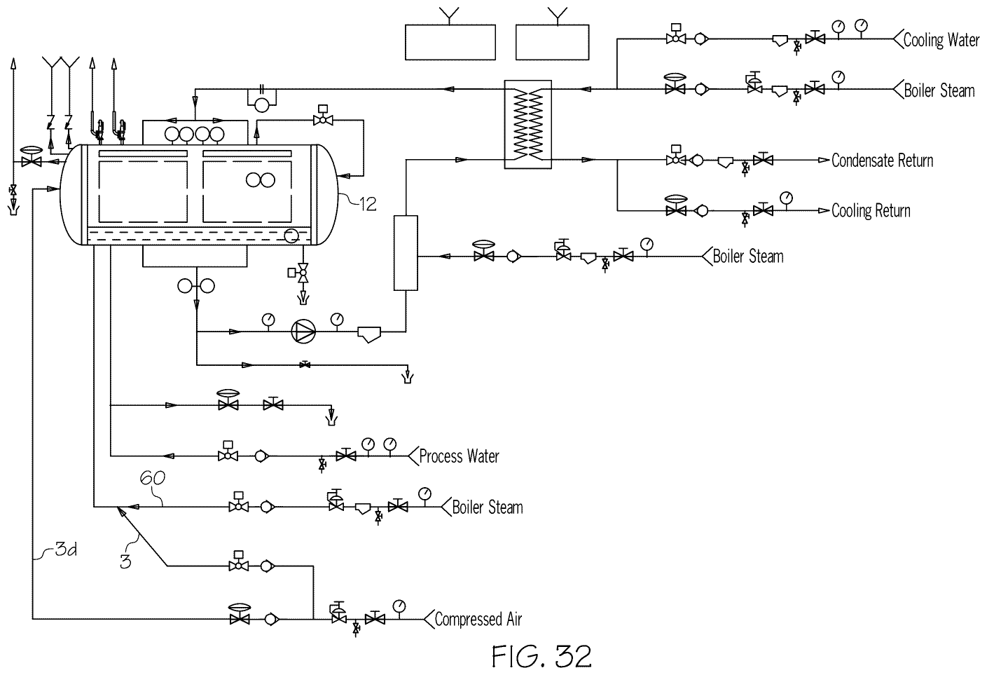

The system schematic of FIG. 32 is similar to that of FIG. 11, but in FIG. 32 the compressed air path 3, in addition to joining the boiler steam path 60, also has a direct path 3d to the vessel.

1. A retort system, comprising:
a vessel defining an interior volume, the vessel including at least one door movable between open and closed positions;
a support arrangement within the interior volume for receiving at least one product holding structure holding one or more packaged products to be treated;
a heat exchange system, including a liquid circulation path having a discharge side, the heat exchange system configured to move a heat exchange liquid from the suction side to the discharge side;
wherein the discharge side is fluidly connectable to a distribution feed system configured for feeding heat exchange liquid into the at least one product holding structure;
wherein the suction side is fluidly connectable to pull heat exchange liquid from a lower region of the interior volume;
a control system configured to:
(a) operate the heat exchange system such that heat exchange fluid is: (i) pulled from the interior vessel volume via the suction side, (ii) delivered through the pump and back to the interior vessel volume via the discharge side, (iii) into the at least one product holding structure via the distribution feed system, and (iv) through and out of the at least one product holding structure to the interior vessel volume;
(b) monitor an indicator of a fill condition of the at least one product holding structure;
(c) after the indicator indicates that the fill condition is achieved, drain some heat exchange liquid from the interior vessel volume, until a target processing level for the heat exchange liquid within the interior vessel volume and external of the at least one product holding structure has been reached, wherein the target processing level is below a level of heat exchange liquid within the at least one food product holding structure.

2. The retort system of claim 1, wherein the target processing level is high enough to submerge a set of bottom outlet openings of the at least one product holding structure.

3. The retort system of claim 1, wherein the draining operation occurs via a drain path that is separate from the liquid circulation path or that partially overlaps with the liquid circulation path.

4. The retort system of claim 1, wherein the control system is configured such that, prior to step (a), the interior vessel volume is filled with heat exchange liquid to a preheat level, wherein the preheat level comprises a first preheat level and a second preheat level, the first preheat level being below the at least one product holding structure and the second preheat level being at a height that submerges part of the at least one product holding structure, wherein filling of the interior vessel volume from the first preheat level to the second preheat level is not initiated or continued unless and until a temperature of the heat exchange liquid in the interior vessel volume is above a temperature of the packaged products.

5. The retort system of claim 1, wherein the control system includes:
a differential pressure monitoring system for monitoring a differential pressure across a pump of the heat exchange system;
and/or
a flow monitoring system associated with the liquid circulation path for monitoring volumetric flow along the liquid circulation path;
and/or
a distribution feed system liquid level monitoring system for monitoring a level of heat exchange fluid within the distribution feed system;
and/or
a distribution feed system pressure level monitoring system for monitoring a pressure condition in the distribution feed system;
and/or
an interior vessel volume pressure level monitoring system;
and/or
a interior vessel volume liquid level monitoring system for monitoring a level of the heat exchange liquid within the interior vessel volume and external of the at least one product holding structure;
and/or
a vessel temperature monitoring system for monitoring a temperature of the heat exchange fluid in the interior vessel volume and external of the at least one product holding structure;
and/or
a distribution feed system temperature monitoring system for monitoring a temperature of the heat exchange liquid in the distribution feed system.

6. The retort system of claim 5, wherein the distribution feed system liquid level monitoring system is used, at least in part, to verify that the fill condition is achieved, wherein the fill condition is the at least one product holding structure being filled with the heat exchange liquid.

7. The retort system of claim 5, wherein the flow monitoring system is used, at least in part, to verify that the fill condition is achieved, wherein the fill condition is the at least one product holding structure is filled with heat exchange liquid.

8. The retort system of claim 5, wherein the vessel temperature monitoring system and the distribution feed system temperature monitoring system are provided, and the control system is further configured such that a differential temperature between the systems in excess of a set threshold is utilized to take a control action, such as an alarm or an alert.

9. The retort system of claim 5, wherein the distribution feed system pressure level monitoring system and the interior vessel pressure level monitoring system are provided, and the control system is further configured such that a differential pressure between the systems in excess of a set threshold is utilized to take a control action, such as an alarm or alert.

10. The retort system of claim 1,
wherein the distribution feed system comprises at least one plenum, and the plenum includes each of:
an associated temperature sensor for indicating pressure within the plenum; and
an associated level sensor for indicating a level of heat exchange liquid within the plenum;
wherein the control system is configured to take at least one control action based upon the temperature sensor indicating a predefined temperature condition and/or the level sensor indicating a predefined level condition.

11. The retort system of claim 1, wherein the liquid circulation path includes a direct steam injection heating arrangement for injecting steam into the liquid circulation path between the suction side and the discharge side of the liquid circulation path for heating heat exchange liquid.

12. The retort system of claim 11, wherein the liquid circulation path further includes a heat exchanger for heating heat exchange liquid.

13. The retort system of claim 1,
wherein the at least one product holding structure includes a first product holding structure and a second product holding structure;
wherein an actuation system is configured to move the first and second product holding structures between insertion/removal heights within the vessel and processing heights within the vessel at which processing heights the first and second product holding structures engage with the distribution feed system, wherein the actuation system comprises:
a first elongate bladder positioned for moving the first product holding structure, but not the second product holding structure, and a second elongated bladder positioned for moving the second product holding structure, but not the first product holding structure;
and/or
a first elongate bladder positioned for moving a first lift rail associated with the first product holding structure and a second lift rail associated with the second product holding structure, wherein a degree of movement of the first lift rail is at least partly independent of a degree of movement the second lift rail, and visa versa.

14. The retort system of claim 1, wherein the distribution feed system comprises at least one plenum within the interior vessel volume, and a vent path from the plenum into the interior vessel volume.

15. A method for heat treating packaged products, the method comprising the steps of:
using a retort vessel having an interior vessel volume, a heat exchange liquid circulation path having a discharge side, a pump, a suction side, and a distribution feed system in fluid connection with the discharge side;
using at least one product holding structure holding packaged products;
inserting the at least one product holding structure into the vessel;
filling the interior vessel volume with a heat exchange liquid to a preheat level;
heating the heat exchange liquid within the vessel to at least a target preheat temperature;
after the target preheat temperature has been reached, operating the pump such that exchange fluid is: (i) pulled from the interior vessel volume via the suction side, (ii) delivered through the pump and back to the interior vessel volume via the discharge side, (iii) into the at least one product holding structure via the distribution feed system engaged with the product holding structures, and (iv) through and out of the at least one product holding structure to the interior vessel volume;
monitoring an indicator of a fill condition of the at least one product holding structure;
after the indicator indicates that the at least one product holding structure is filled with the heat exchange liquid, draining some heat exchange liquid from the interior vessel volume, until a target processing level for the heat exchange liquid within the interior vessel volume has been reached.

16. The method of claim 15, wherein the preheat level comprises a first preheat level and a second preheat level, the first preheat level being below the at least one product holding structure is the second preheat level being at a height that submerges part of the at least one product holding structure, wherein filling of the interior vessel volume from the first preheat level to the second preheat level is not initiated or continued unless and until a temperature of the heat exchange liquid in the interior vessel volume is above a temperature of the packaged products.

17. The method of claim 16, wherein the target processing level is sufficiently high to submerge a set of bottom outlet openings of the at least one product holding structure.

18. A retort system, comprising:
a vessel defining an interior volume;
a product holding structure configured to be received within the interior volume, the product holding structure comprising:
one or more inlet openings that together define a first flow area for receiving heat exchange liquid and one or more outlet openings that together define a second flow area for outflow of heat exchange liquid, the second flow area being smaller than the first flow area for limiting flow of heat exchange liquid out of the product holding structure;
a heat exchange liquid flow system that is configured to direct heat exchange liquid into the product holding structure causing the product holding structure to fill with heat exchange liquid to at least a submersion level above products within the product holding structure while a level of heat exchange liquid outside the product holding structure and within the interior volume remains below the submersion level;
at least one level sensor for monitoring liquid level within the interior volume and external of the product holding structure.

19. The retort system of claim 18, wherein the heat exchange liquid flow system comprises a distribution feed system configured for engaging the product holding structure and delivering heat exchange liquid into the at least one product holding structure.

20. The retort system of claim 19, wherein the system further comprises:
a flow monitoring system associated with the liquid circulation path for monitoring volumetric flow along the liquid circulation path;
and/or
a liquid level monitoring system for monitoring a level of heat exchange fluid within the distribution feed system;
and/or
a distribution feed system temperature monitoring system for monitoring a temperature of the heat exchange liquid in the distribution feed system.
